(19) United States
(12) Patent Application Publication
(10) Pub. No.: US 2026/0317195 A1
(43) Pub. Date: Oct. 15, 2026

(54) HIGH ENTROPY LAYERED MATERIALS FOR BATTERIES

(71) Applicant: The Trustees of Boston College, Chestnut Hill, MA (US)

(72) Inventors: Alexis Grimaud, Cambridge, MA (US); Pasindu Viduranga Karawita Welewattage, Brighton, MA (US)

(21) Appl. No.: 19/464,368

(22) Filed: Jan. 29, 2026

Related U.S. Application Data
(60) Provisional application No. 63/751,744, filed on Jan. 30, 2025.

(51) Int. Cl. C01G 53/502; H01M 4/02; H01M 4/505; H01M 4/525

(52) U.S. Cl. CPC C01G 53/502; H01M 4/505; H01M 4/525; C01P 2002/72; C01P 2002/88; C01P 2006/40; H01M 2004/028

(57) ABSTRACT

An electrode material having the formula Liₓ(M1ₙ₁M2ₙ₂M3ₙ₃M4ₙ₄M5ₙ₅M6ₙ₆)O₂ in which M1, M2, M3, M4, M5, and M6 are different and are each selected from a 3d transition metal, a 4d transition metal, a 5d transition metal, Si, Ge, Sn, Al, Ga, In, and Sb, x is 0 to 1, each of n1, n2, n3, and n4 is 0.2 to 0.25, each of n5 and n6 is 0 to 0.2, and the material has a configurational entropy greater than 1.35R. Also provided is a method for preparing the electrode material and an electrode material prepared by the method.

### CROSS-REFERENCE TO RELATED APPLICATION

This Application claims the benefit of and priority to U.S. Provisional Application 63/751,744 filed on Jan. 30, 2025. The content of the prior application is hereby incorporated by reference in its entirety.

### BACKGROUND

Substitution chemistry has been pivotal to the development of intercalation materials for rechargeable batteries, using materials including LiNiO₂, LiCoO₂, LiNiₓCo_{y}Al_{z}O₂ (NCA), and LiNiₓMn_{y}Co_{z}O₂ (NMC), in which each transition metal contributes to redox activity, structural robustness, and thermal stability. Yet, their structural instability under high voltage operation remains the principal limitation to further performance enhancement.

These materials preferably have a stoichiometric layered phase, all crystallizing in O3-type structure. Upon delithiation at high potential, they undergo slab-gliding transitions causing sharp interlayer collapse and irreversible mechanical damage.

Beyond redox driven instabilities, layered oxides face an additional and equally restrictive limitation in their narrow compositional miscibility window beyond ternary systems. Attempts to incorporate more transition metal species frequently resulted in phase separation or multiphase coexistence at room temperature. This instability originates from the positive formation enthalpy (ΔH) among competing cations in the layered lattice. As the configurational entropy term (TΔS) diminishes upon cooling, the system spontaneously de-mixes into lower entropy end members. As a result, the accessible compositional design space for layered oxides has remained confined to a narrow set of ternary or lightly doped chemistries.

The need exists to develop electrode materials that overcome these drawbacks.

### SUMMARY

To meet the need set forth above, an electrode material is provided having the formula Liₓ(M1ₙ₁M2ₙ₂M3ₙ₃M4ₙ₄M5ₙ₅M6ₙ₆)O₂, in which M1, M2, M3, M4, M5, and M6 are different and are each selected from a 3d transition metal, a 4d transition metal, a 5d transition metal, Si, Ge, Sn, Al, Ga, In, and Sb, x is 0 to 1, each of n1, n2, n3, and n4 is 0.2 to 0.25, each of n 5 and n6 is 0 to 0.2, and the material has a configurational entropy greater than 1.35 R, R being the universal gas constant.

Also disclosed is a method for preparing the electrode material by (i) obtaining a dry sol-gel comprising at least 4 different metal ions selected from the group consisting of a 3d transition metal, a 4d transition metal, a 5d transition metal, Si, Ge, Sn, Al, Ga, In, and Sb (ii) calcining the dry sol-gel at 150 °C to 500 °C to form a powder, (iii) grinding the powder together with a lithium-containing compound to form a mixture, (iv) heating the mixture to a temperature of 800 °C to 1200 °C, and (v) quenching the heated mixture from a temperature of 800 °C to 1050 °C to a temperature below 200 °C.

An electrode material prepared by the above method is also within the scope of the invention.

The details of one or more embodiments are set forth in the description and the examples below. Other features, objects, and advantages will be apparent from the detailed description, from the drawings, and also from the appended claims.

### BRIEF DESCRIPTION OF THE DRAWINGS

The description below refers to the accompanying drawings, of which:

FIG. 1 shows powder XRD patterns and Le Bail refinement of the as-synthesized phases of LiNi_{0.2}Mn_{0.2}Co_{0.2}Fe_{0.2}Ti_{0.2}O₂;

FIG. 2 shows synchrotron XRD (λ=0.729575 Å) patterns of the as-synthesized phases of LiNi_{0.2}Mn_{0.2}Co_{0.2}Fe_{0.2}Ti_{0.2}O₂ (* denotes the impurities);

FIG. 3 shows Differential Scanning Calorimetry (DSC) data for the formation of LiNi_{0.2}Mn_{0.2}Co_{0.2}Fe_{0.2}Ti_{0.2}O₂ starting from the precursors listed below;

FIG. 4 shows voltage profiles of NMCFT-25 (bottom panel), NMCFT-900 (middle panel), and NMCFT-1050 (top panel) within the voltage window of 1.2-5.0 V at C/10 and room temperature. Extra Li intercalation of NMCFT-900 between 1.0-3.0 V is shown (middle panel);

FIG. 5A shows the galvanostatic cycle of NMCFT-900 within the voltage window of 1.2-5.0 V at C/10 and room temperature;

FIG. 5B shows the galvanostatic cycle of NMCFT-900 within the voltage window of 1.0-3.0 V at C/10 and room temperature;

FIG. 5C shows the galvanostatic cycle of NMCFT-900 within the voltage window of 0.5-3.0 V at C/10 and room temperature;

FIG. 5D shows the galvanostatic cycle of NMCFT-900 within the voltage window of 1.0-5.0 V at C/10 and room temperature;

FIG. 6A shows the cycling behavior of NMCFT- 900 at 55 °C between 1.0-4.75 V;

FIG. 6B shows the capacity retention and coulombic efficiency of NMCFT-900 at C/10 and at 55 °C;

FIG. 6C shows capacity versus cycle number of NMCFT-900 cycled between 1.0-5.0 V at RT;

FIG. 6D shows capacity versus cycle number of NMCFT-900 cycled between 1.0-4.75 V at 55 °C;

FIG. 7A shows Operando XRD data collected during the synthesis of NMCA between 900 °C and 1050 °C highlighting the evolution of the (003) peak and (104) peak of the layered structure (space group R3̅m) and the (002) peak of the DRX structure (space group Fm3̅m) upon heating;

FIG. 7B shows Operando XRD data collected during the synthesis of NMCA between 900 °C and 1050 °C;

FIG. 7C shows Operando XRD data collected during the synthesis of NMCFTA between 900 °C and 1050 °C;

FIG. 7D shows ex situ XRD patterns collected for the indicated materials quenched at 900 °C;

FIG. 7E shows DSC curve of the indicated compositions between room temperature and 1050 °C; and

FIG. 7F shows voltage profiles for each material quenched from 900 °C recorded at C/10 at room temperature.

### DETAILED DESCRIPTION

As set forth in the SUMMARY section, an electrode material is disclosed having the formula Liₓ(M1ₙ₁M2ₙ₂M3ₙ₃M4ₙ₄M5ₙ₅M6ₙ₆)O₂. M1, M2, M3, M4, M5, and M6 are different and are each selected from a 3d transition metal, a 4d transition metal, a 5d transition metal, Si, Ge, Sn, Al, Ga, In, and Sb. In certain embodiments, each of M1, M2, M3, M4, M5, and M6 is selected from the group consisting of Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Si, Ge, Sn, Al, Ga, In, and Sb.

In the formula above, x can be 0 to 1 (e.g., 0.1 to 0.99, 0.15 to 0.8, 0.2 to 0.6, 0, 0.25, 0.33, 0.5, 0.67, 0.75, and 1), n1-n4 can be 0.2 to 0.25 (e.g., 0.2 to 0.24, 0.21 to 0.25, 0.2, 0.21, 0.22, 0.23, 0.24, and 0.25), and n5 and n6 can be 0 to 0.2 (e.g., 0 to 0.1, 0 to 0.15, 0.1 to 0.2, 0.15 to 0.2, 0, 0.1, 0.125, 0.15, 0.175, and 0.2).

In a particular electrode material, M1, M2, M3, and M4 are Ni, Mn, Co, and Fe, respectively, n1 to n4 are each 0.25, and M5 and M6 are absent, i.e., n5 and n6 are both 0. Additional electrode materials include those in which: (i) M1, M2, M3, and M4 are Ni, Mn, Co, and Ti, respectively, n1 to n4 are each 0.25, and M5 and M6 are absent; (ii) M1, M2, M3, M4, and M5 are Ni, Mn, Co, Fe, and Ti, respectively, n1 to n5 are each 0.2, and M6 is absent (n6=0); (iii) M1, M2, M3, and M4 are Ni, Mn, Co, and Al, respectively, n1 to n4 are each 0.25, and M5 and M6 are absent (n5 and n6 are both 0); and (iv) M1, M2, M3, M4, M5, and M6 are Ni, Mn, Co, Fe, Ti, and Al, respectively, and n1 to n6 are each 0.2. A specific electrode material has the formula LiNi_{0.2}Mn_{0.2}Co_{0.2}Fe_{0.2}Ti_{0.2}O₂.

The electrode material described above has a configurational entropy greater than 1.35 R, preferably from 1.35 R to 1.7 R (e.g., 1.3 R, 1.4 R, 1.45 R, 1.5 R, 1.525 R, 1.55 R, 1.57 R, 1.6 R, 1.625 R, 1.65 R, 1.675 R, and 1.7 R) in which R is the universal gas constant.

Further, the electrode material has a discharge capacity of at least 170 mAh g⁻¹ and as high as 390 mAh g⁻¹ (e.g., 170, 175, 200, 225, 250, 275, 300, 325, 350, 375, and 390 mAh g⁻¹).

The electrode material has a layered high entropy structure or a disordered rock salt (DRX) high entropy structure, or both. The electrode material thus has a R3̅m structure or a combination of R3̅m and Fm3̅m structures. The electrode material preferably contains domains of 0.1 to 100 micrometers in diameter (e.g., 0.2 to 50 μm, 0.5 to 30 μm, 0.8 to 20 μm, 1 to 10 μm, 2 μm, 3 μm, and 5 μm). Each domain includes a DRX structure inside the layered structure. These domains are typically chemically homogeneous, i.e., the chemical composition of the DRX structure is the same as that of the layered structure. Not to be bound by theory, these domains contribute to the enhanced electrochemical performance and stability of the electrode material. In certain embodiments, the electrode material has a combination of the layered structure and the DRX structure, in which the weight ratio of the layered structure and the DRX structure is 95:5 to 5:95 (e.g., 9:1 to 1:9, 85:15 to 15:85, 5:1 to 1:5, 4:1 to 1:4; 7:3 to 3:7, 3:2 to 2:3; and 1:1).

In a particular embodiment, the electrode material has a layered high entropy structure and 30 to 35% by mass of a DRX high entropy structure.

Also disclosed is a method for preparing the electrode material described above.

The method included a step of obtaining a dry sol-gel comprising at least 4 different metal ions selected from a 3d transition metal, a 4d transition metal, a 5d transition metal, Si, Ge, Sn, Al, Ga, In, and Sb. In certain methods, the metal ions are selected from Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Si, Ge, Sn, Al, Ga, In, and Sb. In a preferred method, the metal ions are selected from Ni, Mn, Co, Fe, Ti, and Al (e.g., Ni, Mn, Co, and Fe; Ni, Mn, Co, and Ti; Ni, Mn, Co, Fe, and Ti; Ni, Mn, Co, and Al; and Ni, Mn, Co, Fe, Ti, and Al). The dry sol-gel can be prepared by any means known in the art, such as that set forth below in Example 2.

The method also includes a step of calcining the dry sol-gel at 150 °C to 500 °C (e.g., 150 °C, 175 °C, 200 °C, 225 °C, 250 °C, 275 °C, 300 °C, 325 °C, 350 °C, 375 °C, 400 °C, 425 °C, 450 °C, 475 °C and 500 °C, to form a powder. The calcining can be performed for at least one hour.

In the method, the powder is ground together with a lithium-containing compound to form a mixture. The lithium-containing compound can be, but is not limited to, Li(Ch₃COO)·2H₂O, Li(Ch₃COO), LiOH, LiOH·H₂O, Li₂CO₃, and Li₂O.

The method also features a step of heating the mixture to a temperature of 800 °C to 1200 °C (e.g., 800 °C, 825 °C, 850 °C, 875 °C, 900 °C, 925 °C, 950 °C, 975 °C, 1000 °C, 1025 °C, 1050 °C, 1075 °C, 1100 °C, 1125 °C, 1150 °C, 1175 °C, and 1200 °C). In certain methods, the temperature is 900 °C or 1050 °C.

The heating can be at a ramp rate of 1 °C min⁻¹ to 15 °C min⁻¹, preferably 5 °C min⁻¹. The mixture is held at the desired temperature for 1 to 100 hours (e.g., 1, 5, 10, 12, 20, 30, 40, 50, 60, 70, 80, 90, and 100 hours), In a specific method, the holding time is 12 hours.

Finally, the method includes a step of quenching the heated mixture from a temperature of 800 °C to 1050 °C (e.g., 800 °C, 825 °C, 850 °C, 875 °C, 900 °C, 925 °C, 950 °C, 975 °C, 1000 °C, 1025 °C, and 1050 °C) to a temperature below 200 °C at a rate of at least 20 °C s⁻¹. In preferred methods, the heated mixture is quenched from 900 °C or from 1050 °C.

The invention also encompasses an electrode material produced by the method described above. The electrode material can be produced by the above method in which the heated mixture is quenched from a temperature of 900 °C, or quenched from a temperature of 1050 °C. The electrode material is preferably produced by the above method in which the metal ions are selected from Ni, Mn, Co, Fe, Ti, and Al.

Also within the scope of the invention is a battery that includes a positive electrode, a negative electrode, and an electrolyte, in which the positive electrode contains the electrode material described, supra.

Without further elaboration, it is believed that one skilled in the art can, based on the disclosure herein, utilize the present disclosure to its fullest extent. The following specific examples are, therefore, to be construed as merely descriptive, and not limitative of the remainder of the disclosure in any way whatsoever. All publications and patent documents cited herein are incorporated by reference in their entirety.

### EXAMPLES

### Example 1: Materials and Methods

All the compounds were synthesized using modified sol-gel method. Stoichiometric amounts of Ni(CH₃COO)₂·4H₂O (99%, Thermo Scientific®), Co(CH₃COO)₂·4H₂O (98%, Thermo Scientific®), Mn((CH₃COO)₂·4H₂O (99%, Thermo Scientific®), Fe(CH₃COO)₂ (95%, Thermo Scientific®), AlNO₃·9H₂O (99.999% Thermo Scientific®), and Ti[OCH(CH₃)₂] 4 (97%, Thermo Scientific®) were dissolved in ethanol to form a metal-ion solution (Solution A). A separate solution (Solution B) was prepared using citric acid as chelating agent, with the mole ratio of citric acid to total metal ions fixed at 1.2:1, dissolved in ethanol. Then the solution B was gradually added to solution A while continuously stirring at 650 rpm and maintaining a temperature of 90 °C. The pH value was adjusted in real-time using NH₃·H₂O to pH 8 to catalyze the hydrolysis process. The resulting gel was placed in a drying oven for 12 hours to obtain a dry gel. The dry gel powder was then placed in a muffle furnace and pre-calcined at 450 °C for 6 hours in air. The resulting powder was ground with Li(CH₃COO)·2H₂O (99+%, Thermo Scientific®) and then heated to the desired temperature with a ramp rate of 5 °C min⁻¹. The duration of sintering was 12 h. The material was subsequently quenched at specific temperatures or cooled down to room temperature to obtain the final materials.

### Electrochemistry

Electrochemical tests were conducted using a BCS-800® series potentiostat (Biologic) under constant-current conditions. Half-cells were assembled with the active material powder electrodes paired against Li metal (MSE®) as the counter/reference electrode, using Whatman GF/A glass-fiber separators and LP57 electrolyte (E-Lyte Innovations®). SS304 CR2032 coin-cell hardware (TMAX®) was used for all assemblies, which were carried out inside an argon-filled glovebox. Powder electrodes were prepared by thoroughly grinding the active material (70 wt %) with Super-P carbon black (30 wt %, MSE®) until a homogeneous mixture was obtained. The specific capacities were calculated on the basis of the active-material fraction (70%) within the electrode mixture. Galvanostatic intermittent titration technique (GITT) measurements were performed by applying periodic stepwise galvanostatic 0.5 h pulse at C/10 followed by 6 h relaxation steps.

### Characterization

X-ray diffraction (XRD) measurements were performed using a Bruker® D8 Advance with Cu Kα1/Kα2 incident X-rays (λ1=1.5406 Å, λ2=1.5444 Å). Samples for ex situ XRD measurements were prepared in an argon-filled glovebox in an airtight sample holder (MTI Corporation) with a Kapton window or by covering powder samples loaded on a zero-background holder with Kapton tape. Synchrotron XRD patterns of the as-synthesized compounds and ex-situ samples were obtained at Beamline® 2-1 at SLAC Synchrotron (Menlo Park, California). Operando XRD measurements were carried out using an operando electrochemical cell with a Be window (Bruker®). In situ temperature resolved XRD was performed by using the MTC-FURNACE furnace with an AlCr radiation heater mounted on the Bruker® D8 Advance diffractometer. The powder is loaded into corundum sample holder and patterns were recorded in the 2θ range of 10-70° at a temperature between 25 °C and 1050 °C. The XRD data were collected in air as function of temperature. The collected diffraction patterns were analyzed using the Le Bail fitting, and Rietveld refinement methods in the FullProf Suite® (version 5.10, 2023). Crystal structure illustrations were produced using VESTA.

Elemental analysis was performed using inductively coupled plasma mass spectrometry (Agilent® 8900 Triple Quadrupole ICP-MS). The samples for ICP-MS were first dissolved in Hf-HNO₃ followed by aqua regia and then diluted with deionized water in a volumetric flask to the appropriate concentration before the measurements.

Differential Scanning Calorimetry (DSC) measurements were performed using a NETZSCH® Simultaneous Thermal Analysis 449 F1 Jupiter/Quadrupole Mass Spectrometer 403 (sSTA-QMS). Precursor powders mixed With Li(CH₃COO)·2H₂O were loaded Into alumina crucible and heated from room temperature to 1050 °C at a heating rate of 1 °C min⁻¹ under air.

For TEM sample preparation, a small amount of the as-synthesized powder was dispersed in ethanol via sonication and drop-cast onto lacey-carbon-supported copper grids (Oxford Instruments®). These grids were mounted on a double-tilt holder and transferred to the TEM. For the cycled samples, powders were collected after disassembling the coin cells, dispersed in DMC, and deposited onto the copper grids. To prevent exposure to air and moisture, these grids were loaded into an Atmos Double Tilt LN2 Vacuum/Inert Gas Transfer Holder (Mel-Build) inside an argon-filled glovebox and transferred to the TEM. STEM HAADF images were taken with a transmission microscope (Titan Themis® Z G3 Cs-corrected S/TEM, Thermo Fisher Scientific at MIT-nano) at 200 kV with spherical aberration corrector. Element mapping with EDS was also carried out using Themis Z G3 at 200 kV along with a Super X-4 quadrant EDS detector (ChemiSTEM® technology). Ti Kα (4.510 keV), Mn Kα (5.898 keV), Fe Kα (6.403 keV), Co Kα (6.929 keV), and Ni Kα (7.477 keV) line were selected during chemical mapping. The probe current was adjusted to be 100 pA with a scanning time of <300 s.

### XAS

X-ray absorption near edge structure (XANES) and extended X-ray absorption fine structure (EXAFS) of Co, Ni, Mn, Fe, and Ti K-edge were measured in fluorescent mode at room temperature at beamline 7-BM QAS of the National Synchrotron Light Source II (NSLS-II), Brookhaven National Laboratory. A Si (111) double-crystal monochromator was used to filter the X-ray beam. Metal foils were used for the energy calibration, and all samples were measured under transmission mode at room temperature. All the ex-situ samples were assembled as coin cells, charged to the designated capacities, and then disassembled and washed with DMC in a glovebox (except for the pristine materials). Additional reference spectra of standards were also measured to facilitate interpretation. The data were processed using the IFEFFIT-based Athena and Artemis programs. Further EXAFS analysis, including wavelet transform (WT), was carried out using the IGOR pro software with Wavelet2.ipf module for the calculation.

### Example 2: Sol-gel synthesis

A modified sol-gel method was used to synthesize Li(Ni_{0.2}Mn_{0.2}Co_{0.2}Fe_{0.2}Ti_{0.2})O₂ material. Stoichiometric amounts of Ni(CH₃COO)₂·4H₂O, Co(CH₃COO)₂·4H₂O, Mn(CH₃COO)₂·4H₂O, Fe(CH₃COO)₂, and Ti[OCH(CH₃)₂]₄ were dissolved in ethanol to form a metal-ion solution (Solution A). A separate solution (Solution B) was prepared using citric acid as chelating agent, with the mole ratio of citric acid to total metal ions fixed at 1.2:1, dissolved in ethanol. Then, Solution B was gradually added to Solution A while continuously stirring at 650 rpm and maintaining a temperature of 90 °C. The pH value was adjusted in real-time using NH₃·H₂O to pH 8 to catalyze the hydrolysis process. The resulting gel was placed in a drying oven for 12 hours to obtain a dry gel.

The dry gel powder was then placed in a muffle furnace and pre-calcined at 450 °C for 6 hours in air. The resulting powder was ground with Li(CH₃COO)·2H₂O and then heated to the desired temperature with a ramp rate of 5°C/min. The material was subsequently quenched from 1050 °C or 900 °C, or cooled down to room temperature to obtain the final materials.

### Example 3: Characterization of LiNi_{0.2}Mn_{0.2}Co_{0.2}Fe_{0.2}Ti_{0.2}O₂

Three high-entropy phases with the composition LiNi_{0.2}Mn_{0.2}Co_{0.2}Fe_{0.2}Ti_{0.2}O₂ (NMCFT) were synthesized as described above. These phases were prepared by calcination at 1050 °C for 12 hours followed by quenching to room temperature (NMCFT-1050), calcination at 900 °C for 12 hours followed by quenching to room temperature (NMCFT-900), and calcination at 1050 °C for 12 hours followed by gradual cooling to room temperature (NMCFT-25).

The compositions of the three phases, verified by inductively coupled plasma-mass spectrometry (ICP-MS), show an average elemental ratio across different samples of Li, Ni, Mn, Co, Fe, and Ti as 0.99:0.20:0.19:0.21:0.19:0.20. This yields a true bulk stoichiometric composition of Li_{0.99}Ni_{0.20}Mn_{0.19}Co_{0.21}Fe_{0.19}Ti_{0.20}O₂, which closely aligns with the target composition LiNi_{0.2}Mn_{0.2} Co_{0.2} Fe_{0.2}Ti_{0.2}O₂.

### Example 4: Characterization of LiNi_{0.2}Mn_{0.2}Co_{0.2}Fe_{0.2}Ti_{0.2}O₂ by XRD

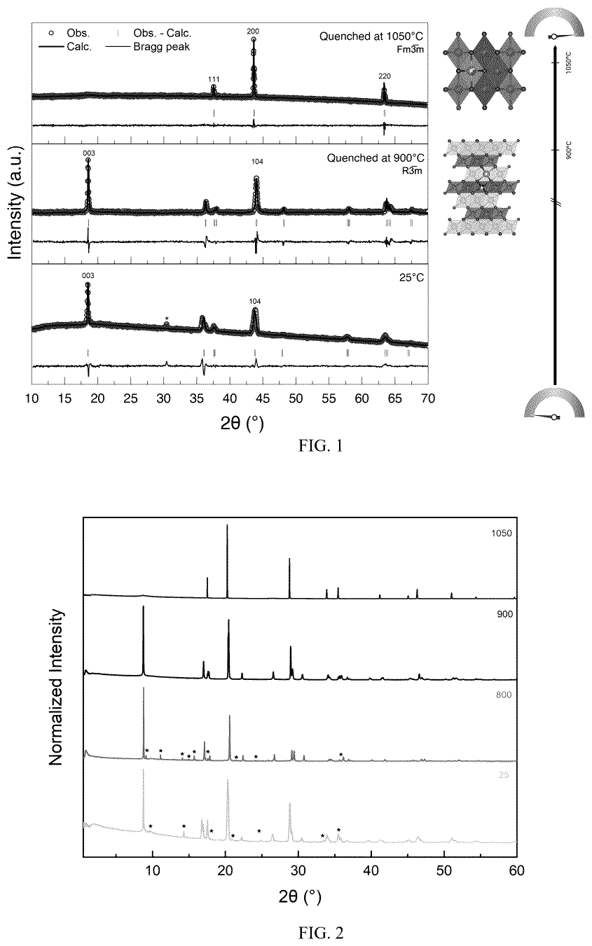

Structural properties were analyzed using laboratory powder X-ray diffraction (XRD) with Le Bail refinement. Powder XRD analysis revealed that the structure of LiNi_{0.2}Mn_{0.2}Co_{0.2}Fe_{0.2}Ti_{0.2}O₂ varies with calcination temperature. The NMCFT-1050 phase exhibits a disordered rock-salt (DRX) structure with the Fm3̅m space group (a=b=c=4.149 Å), whereas NMCFT-900 displays an α-NaFeO₂ type layered structure with the R3̅m space group (a=b=2.902 Å, c=14.351 Å) with the co-existence of a second phase with a DRX structure with the Fm3̅m space group. Quantitative analysis estimates that the DRX phase is around 30% by mass. See FIG. 1. NMCFT-25 shows a layered structure also in the R3̅m space group as majority phase, but with impurities evident in the XRD data, unlike the phase-pure structures observed in NMCFT-1050 and NMCFT-900. See FIG. 1.

The differences between the phases at each quenching temperature are even more pronounced when examined by synchrotron XRD. The results are shown in FIG. 2. Peaks marked with an asterisk (*) indicate impurity phases that are not indexed by the layered phase. The observation of impurities even at 800 °C suggests that the pure layered (R3̅m) structure is only stable within a narrow temperature range centered around 900 °C, and the impurity phase fraction disappears with increasing temperature, confirming that the layered structure is indeed entropically stabilized at intermediate higher temperatures.

### Example 5: Characterization of LiNi_{0.2}Mn_{0.2}Co_{0.2}Fe_{0.2}Ti_{0.2}O₂ by DSC

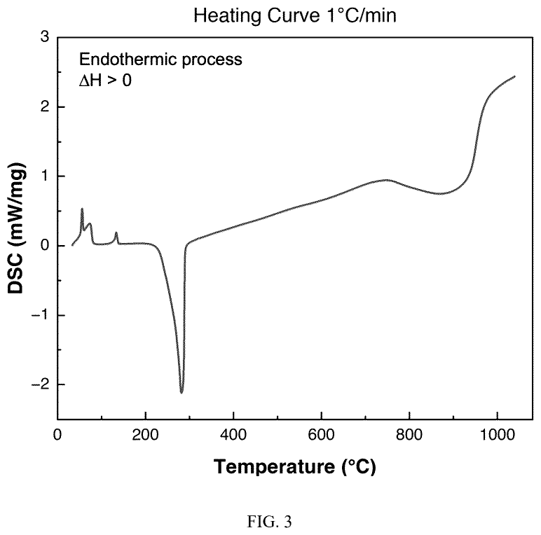

Reversibility and compositionally dependent solvus lines (limit of solubility in a solid solution) are indicative of an entropy-driven process. This transition from a multiphase to a single-phase state should be endothermic, akin to a solid-solid transformation similar to melting, which requires an external heat source. To explore this, differential scanning calorimetry (DSC) was used to analyze the phase transformation. FIG. 3 shows the calorimetric results, highlighting a distinct endothermic process within the target temperature range. At lower temperatures (<400 °C) several thermal features are evident accompanied by mass loss, which arise from dehydroxylation and decarbonation of residual surface species and exothermic feature which can be attributed to crystallization. At higher temperatures, DSC reveals a broad thermal anomaly composed of a shallow exothermic shoulder followed by a net endothermic deviation between ~850 °C and 970 °C, consistent with an entropy-driven transformation. The broad exothermic component is consistent with a continuous (second-order-like) structural adjustment, reflected in a heat-capacity anomaly rather than a latent heat peak, as commonly observed in continuous solid-state transformations.

### Example 6: Characterization of LiNi_{0.2}Mn_{0.2}Co_{0.2}Fe_{0.2}Ti_{0.2}O₂ by TEM

Scanning transmission electron microscopy (STEM) with high-angle annular dark-field imaging (STEM-HAADF) was employed to further investigate the phases formed during the different heat treatments. Despite the bulk XRD data indicating a layered structure when cooled down to room temperature (NMCFT-25), this is not a pure layered compound at the microscopic level. Indeed, Fast Fourier Transformation (FFT) patterns of selected regions within the same particle reveal significant structural heterogeneity, including a layered phase with a higher degree of cation mixing, a disordered rock-salt structure, and a structure resembling a spinel phase.

Energy dispersive spectroscopy (EDS) was used to examine the elemental distribution within the material. Although the bulk composition from inductively coupled plasma spectroscopy (ICP) analysis closely matches the intended stoichiometry, localized Co-rich regions were identified within the NMCFT-25 particles, further demonstrating compositional inhomogeneity at the microscopic scale.

STEM-HAADF imaging of the NMCFT-900 phase reveals a layered structure that persists even at the microscopic level. The corresponding FFT analysis further validated that this phase is a layered structure with nanometer DRX domains, distinct from the NMCFT-25 phase formed upon cooling to room temperature. While some degree of cation mixing is observed within the Li layer, between the transition metal slabs, this mixing is significantly less pronounced compared to NMCFT-25. Additionally, EDS mapping confirms that all elements are homogeneously distributed throughout the NMCFT-900 phase, highlighting its compositional uniformity.

When the material is heated to 1050 °C (NMCFT-1050), it fully transforms into a DRX phase, with no other structures detectable even under STEM-HAADF imaging. The corresponding FFT analysis further confirms the presence of a single DRX phase. Moreover, EDS mapping reveals a homogeneous distribution of all elements throughout the NMCFT-1050 phase, emphasizing its compositional uniformity. This uniformity emphasizes the complete structural transformation achieved at elevated temperatures.

### Example 7: Electrochemical Performance

The electrochemical performance of each active material was evaluated in half-cells using a BCS-800 series potentiostat (Biologic) operating at constant current. These measurements were conducted in cells using a powder electrode of the active material, lithium metal counter electrode, glass fiber separators and LP57 (1M LiPF₆ salt in ethylene carbonate (EC): ethylmethyl carbonate (EMC) 30:70 in volume blend) electrolyte. Powder electrodes were prepared by thoroughly grinding the active material (80% by mass) with Carbon Black (20% by mass, Super-P) until a homogenous mixture was obtained. Coin cells were assembled within an argon-filled glovebox, and galvanostatic cycling was performed at a C/10 rate relative to the theoretical capacity of the cell, unless specified otherwise.

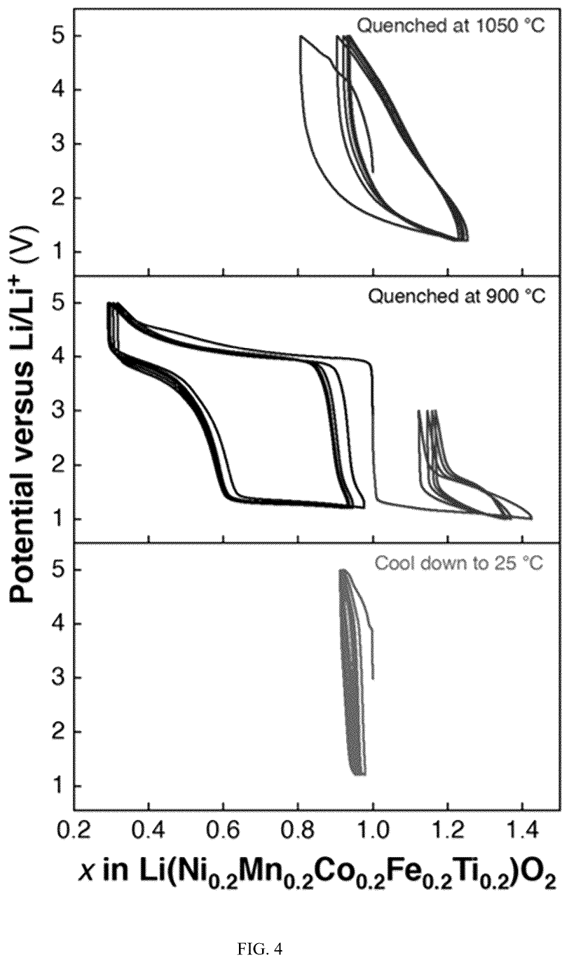

The results are shown in FIG. 4. The first five charge-discharge profiles of NMCFT-25, NMCFT-900, and NMCFT-1050 at a C/10 rate between 1.2 V and 5.0 V reveal markedly different cycling behaviors for the three phases, despite having the same composition. While the XRD patterns of NMCFT-25 and NMCFT-900 suggest structural similarities, their electrochemical behaviors differ significantly. NMCFT-25 exhibits a limited capacity, exchanging less than 0.1 Li during cycling, corresponding to a capacity of less than 30 mAh/g. This limited performance is likely due to the presence of multiple phases within a single particle when cooled to room temperature, obstructing Li diffusion pathways.

In contrast, NMCFT-900, which exhibits chemical homogeneity with the co-existence of the layered structure with nanometric DRX domains (both with the same chemical composition), demonstrates reversible exchange of approximately 0.7 Li, corresponding to a capacity of 225 mAh/g. This phase approaches the maximum theoretical Li exchange capacity, likely due to the unobstructed Li diffusion channels in its layered structure, which was never reported before for this composition.

For NMCFT-1050, forming a DRX structure, a different behavior is observed. Due to the nature of the DRX structure, extensive ball milling with carbon black (over 6 hours) is required to access its electrochemical performance. After ball-milling, this phase exhibits reversible exchange of only approximately 0.3 Li, followed by the intercalation of additional Li below 1.5 V, which all together account for the exchange of about 0.45 Li and a capacity of 128 mAh/g.

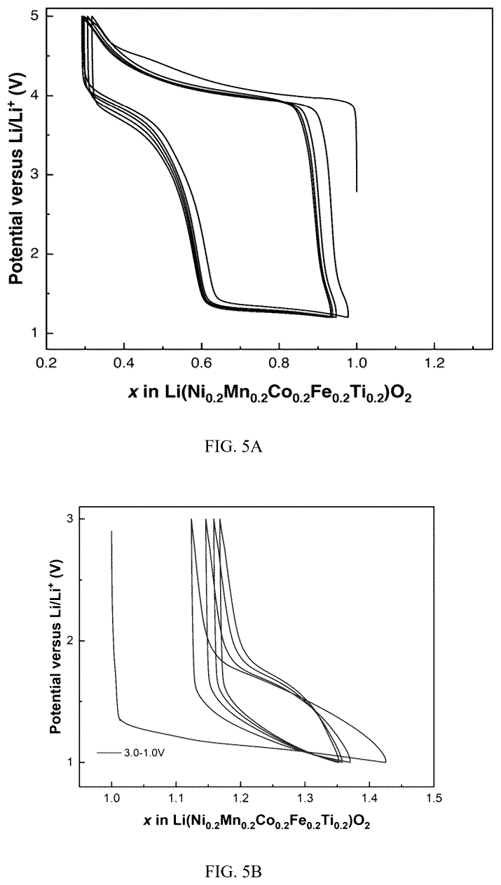

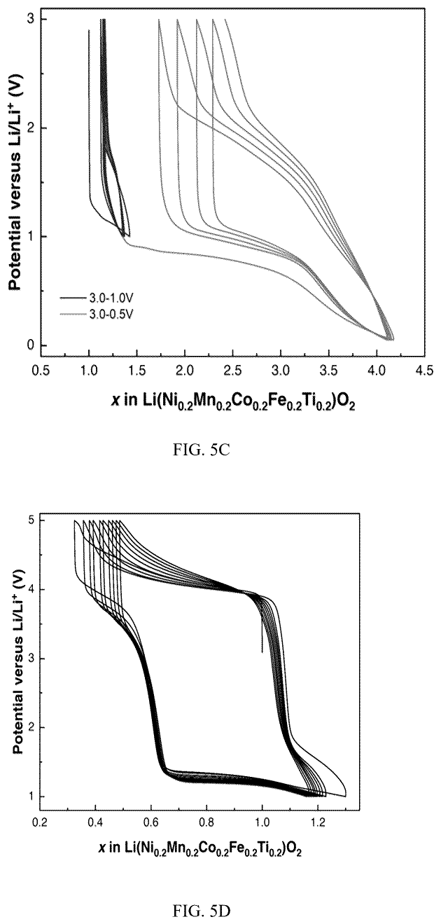

It is also noteworthy that the NMCFT-900 phase demonstrated stable cycling in an extended voltage window with a higher cutoff of 5.0 V using LP57 electrolyte (see FIG. 5A), without requiring any structural modifications or additional optimizations. This characteristic indicates its potential as a high-energy layered cathode material for lithium-ion batteries. Typically, only DRX-type cathodes are capable of operating at such high voltages without structural adjustment. This is the first report of an NMC-type layered cathode material that can cycle with a higher voltage cutoff of 5.0 V without further modifications, highlighting its unique and promising electrochemical performance.

Also notably, this material (NMCFT-900) can reversibly intercalate additional lithium when directly discharged and cycled between 1 V and 3 V. See FIG. 5B. Below 0.75 V, the material undergoes a conversion process, as evident in FIG. 5C. Leveraging this characteristic, NMCFT-900 can be cycled in an extended voltage range of 5 V to 1 V (see FIG. 5D), significantly wider than the typical voltage window of optimized NMC cathodes, which generally operate between maximum region of 2.8 V and 4.5 V. The capacity thus obtained in this extended voltage window was 256 mAh/g.

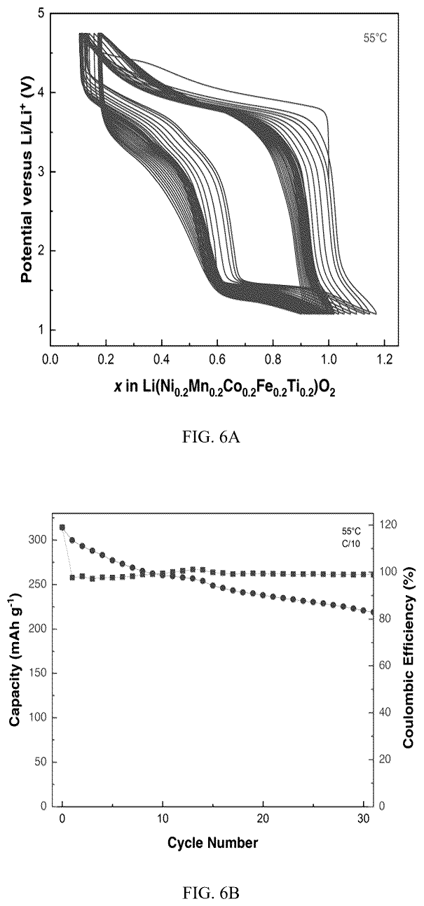

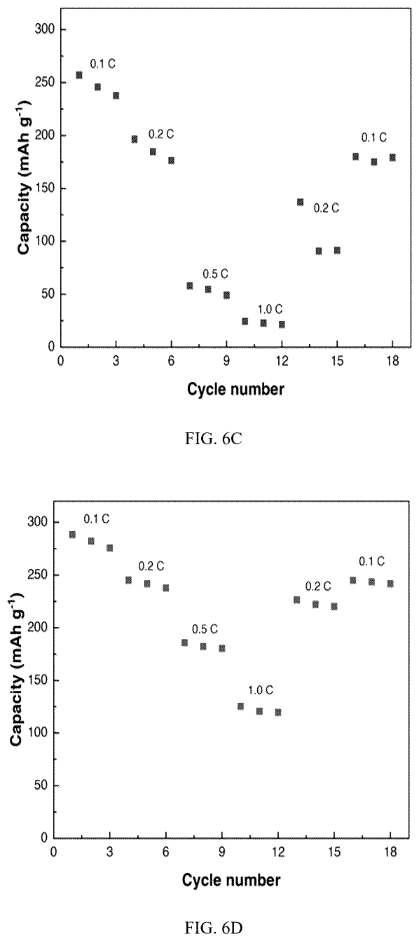

To evaluate the cycling performance and long-term behavior, additional tests were conducted on the NMCFT-900 phase. Shown in FIG. 6A is the cycling behavior of this phase at 55 °C with a C/10 rate and a voltage range of 1.0-4.75 V. The upper cutoff voltage was reduced due to increased electrolyte degradation at elevated temperatures. The material exhibited an initial discharge-specific capacity of 313 mAh/g, which decreased to 225.2 mAh/g after 30 cycles, corresponding to a capacity retention of over 81%. See FIG. 6B. The average coulombic efficiency over these 30 cycles was approximately 99.1%. See FIG. 6B.

A comparison of rate capability and cycling temperatures revealed improved performance at 55 °C, particularly at higher C rates. At room temperature (RT), the material delivered a specific capacity of 257 mAh/g at a C/10 rate but only 24 mAh/g at a 1 C rate. See FIG. 6C. By contrast, at 55 °C and a C/10 rate, NMCFT-900 delivered a specific capacity of around 288 mAh/g, maintaining 185 mAh/g even at a 1 C rate. See FIG. 6D. These findings highlight enhanced capacity retention and cycling behavior at elevated temperatures compared to cycling at RT.

### Example 8: Configurational Entropy

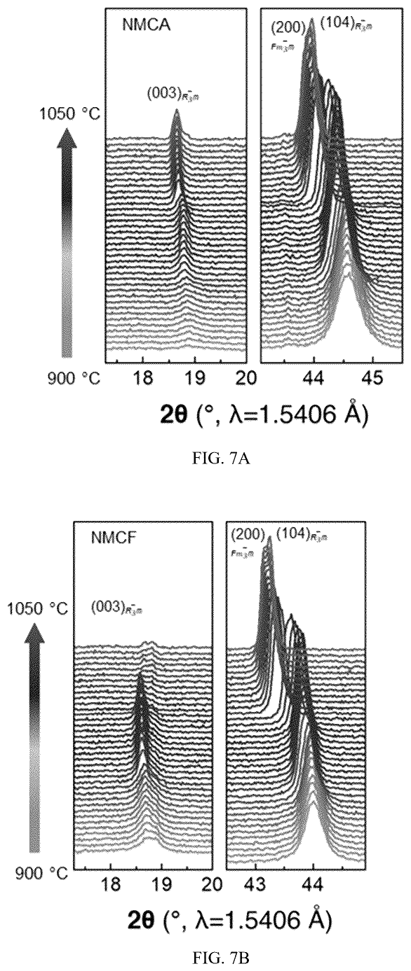

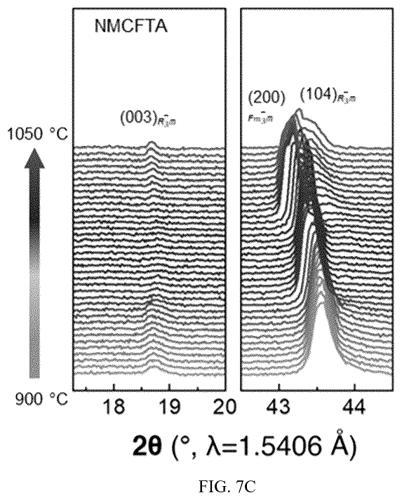

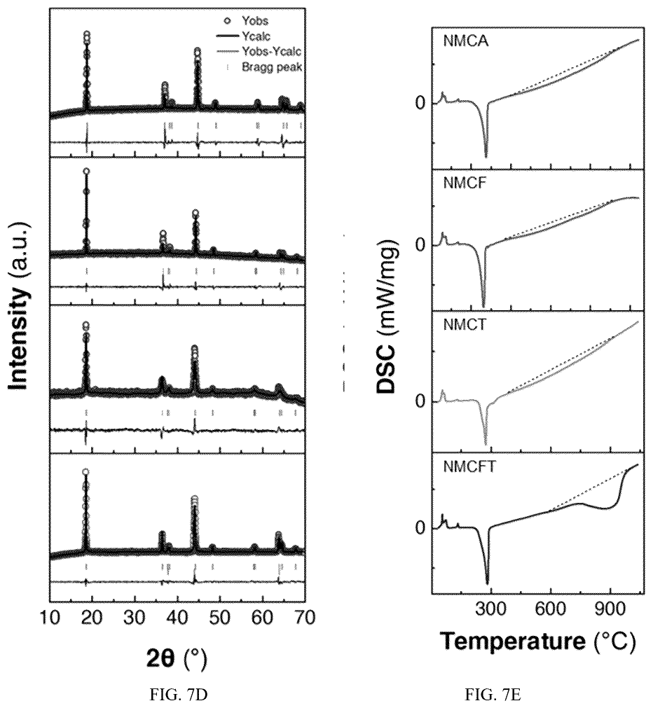

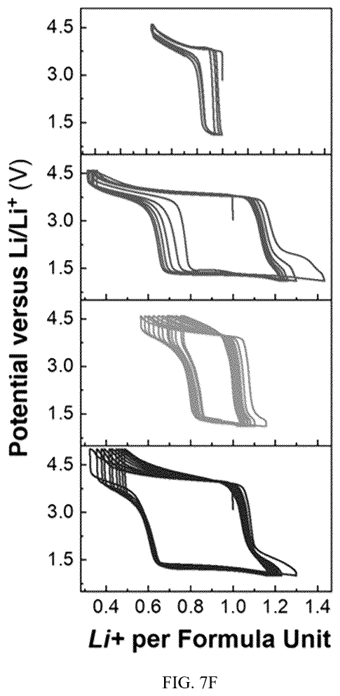

To further examine the role of configurational entropy in shaping phase stability, the five component NMCFT system was compared with several four component analogues LiNi_{0.25}Mn_{0.25}Co_{0.25}Fe_{0.25}O₂ (NMCF), LiNi_{0.25}Mn_{0.25}Co_{0.25}Ti_{0.25}O₂ (NMCT), LiNi_{0.25}Mn_{0.25}Co_{0.25}Al_{0.25}O₂ (NMCA) and a six component Li(Ni_{0.2}Mn_{0.2}Co_{0.2}Fe_{0.2}Ti_{0.2}Al_{0.2})O₂ analogue, to decouple the effect of increasing chemical complexity from other synthesis variables. Operando heating XRD shows that the four component materials behave differently from NMCFT. NMCA is found to remain layered across the entire temperature range up to ~1050 °C (see FIG. 7A) and does not transform into a DRX structure, even at the highest temperatures. Note that the intensity of the peaks at low angles is weaker due to the absorption of the window from the operando cell. Both NMCF and NMCT display a weakened (003) peak at 1050 °C, consistent with increased cation mixing, and the appearance of reflections attributed to DRX at high temperature. However, this transformation is only partial and they do not exhibit a full layered to DRX conversion at high temperature (see FIG. 7B). This finding is consistent with DSC results (see FIG. 7E) that also lack the broad endothermic feature seen in NMCFT, indicating that the entropic term is not large enough to drive the entropy stabilization of the DRX phase. Together, these results suggest that four component compositions do not reach the same entropic threshold required to drive the phase transition pathway observed in NMCFT.

The six component analogue Li(Ni_{0.2}Mn_{0.2}Co_{0.2}Fe_{0.2}Ti_{0.2}Al_{0.2})O₂ was synthetized to test whether increasing the number of cations further enhances entropy driven behavior. Unlike the five component system, the six component material does not become single phase at any temperature (see FIG. 7C). However, the DRX related reflections appear at noticeably lower temperature compared to NMCFT, and their intensity increases more rapidly with heating. This shift toward earlier DRX formation is consistent with a stronger entropic pull that lowers the barrier between layered and DRX configurations. At the same time, the persistent multiphase character implies that the enthalpic penalty in this composition is too large for entropy to fully overcome, preventing the stabilization of a true single-phase material. Across the 4-, 5-, and 6-component series, a clear trend is visible, where increasing the configurational entropy shifts the balance between layered and DRX frameworks. However, to no surprise, the outcome depends on the competition between entropy and enthalpy. NMCFT sits at an intermediate point where the configurational entropy is high enough to enable an entropy-stabilized layered phase at high temperature, yet the enthalpy remains moderate enough which allows the formation of the layered phase to occur at moderate temperature. The four component materials fall below this threshold, while the six-component analogue exceeds the enthalpic limit that entropy can compensate.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

1. An electrode material having the formula Liₓ(M1ₙ₁M2ₙ₂M3ₙ₃M4ₙ₄M5ₙ₅M6ₙ₆)O₂, wherein M1, M2, M3, M4, M5, and M6 are different and are each selected from a 3d transition metal, a 4 d transition metal, a 5d transition metal, Si, Ge, Sn, Al, Ga, and In; x is 0 to 1;
each of n1, n 2, n 3, and n4, independently, is 0.2 to 0.25; each of n 5 and n 6, independently, is 0 to 0.2; and the material has a configurational entropy greater than 1.35 R, in which R is the universal gas constant.

2. The electrode material of claim 1, wherein each of M1, M2, M3, M4, M5, and M6 is selected from the group consisting of Ti, V, Cr, Mn, Fe, CO, Ni, Cu, Zn, Zr, Nb, Mo, Ru, Rh, Pd, Ag, Cd, Hf, Ta, W, Re, Os, Ir, Pt, Au, Si, Ge, Sn, Al, Ga, In, and Sb.

3. The electrode material of claim 1, wherein the material has a discharge capacity of at least 170 mAh g⁻¹.

4. The electrode material of claim 1, wherein M1, M2, M3, and M4 are Ni, Mn, Co, and Fe, respectively, each of n1, n2, n3, and n4 is 0.25, and each of n5 and n6 is 0.

5. The electrode material of claim 1, wherein M1, M2, M3, and M4 are Ni, Mn, Co, and Ti, respectively, each of n1, n2, n3, and n4 is 0.25, and each of n5 and n6 is 0.

6. The electrode material of claim 1, wherein M1, M2, M3, M4, and M5 are Ni, Mn, Co, Fe, and Ti, respectively, each of n 1, n2, 3, n4, and n5 is 0.2, and n6=0.

7. The electrode material of claim 1, wherein M1, M2, M3, and M4 are Ni, Mn, Co, and Al, respectively, each of n1, n2, n3, and n4 is 0.25, and each of n5 and n6 is 0.

8. The electrode material of claim 1, wherein M1, M2, M3, M4, M5, and M6 are Ni, Mn, Co, Fe, Ti, and Al, respectively, and each of n1, n2, n3, n4, n5, and n6 is 0.2.

9. The electrode material of claim 1, wherein the material has a layered or disordered rock salt (DRX) high entropy structure.

10. The electrode material of claim 1, wherein the material has a layered high entropy structure and 30 to 35% by mass of a DRX high entropy structure.

11. A method for preparing the electrode material of claim 1, the method comprising:
obtaining a dry sol-gel comprising at least 4 different metal ions selected from the group consisting of a 3d transition metal, a 4d transition metal, a 5d transition metal, Si, Ge, Sn, Al, Ga, In, and Sb;
calcining the dry sol-gel at 150 °C to 500 °C to form a powder;
grinding the powder together with a lithium-containing compound to form a mixture;
heating the mixture to a temperature of 800 °C to 1200 °C;
quenching the heated mixture from a temperature of 800 °C to 1050 °C to a temperature below 200 °C, thereby forming the electrode material.

12. The method of claim 11, wherein the metal ions are selected from the group consisting of Ti, V, Cr, Mn, Fe, CO, Ni, Cu, Zn, Zr, Nb, Mo, Ru, Rh, Pd, Ag, Cd, Hf, Ta, W, Re, Os, Ir, Pt, Au, Si, Ge, Sn, Al, Ga, In, and Sb.

13. The method of claim 11, wherein the metal ions are selected from the group consisting of Ni, Mn, Co, Fe, Ti, and Al.

14. The method of claim 11, wherein the heated mixture is quenched from a temperature of 900 °C.

15. The method of claim 11, wherein the heated mixture is quenched from a temperature of 1050 °C.

16. A battery comprising a positive electrode, a negative electrode, and an electrolyte, wherein the positive electrode contains the electrode material of claim 1.

17. An electrode material produced by the method of claim 11.

18. The electrode material of claim 17, wherein the heated mixture is quenched from a temperature of 900 °C.

19. The electrode material of claim 17, wherein the heated mixture is quenched from a temperature of 1050 °C.

20. The electrode material of claim 17, wherein the metal ions are selected from the group consisting of Ni, Mn, Co, Fe, Ti, and Al.
